(19) United States
(12) Patent Application Publication
(10) Pub. No.: US 2011/0079011 A1
(43) Pub. Date: Apr. 7, 2011

(54) Electro-repulsive vacuum glazing

(76) Inventor: Anthony Sabo, Arlington, VA (US)

(21) Appl. No.: 12/587,500

(22) Filed: Oct. 1, 2009

(51) Int. Cl. F03G 6/06; E06B 3/663; E06B 3/677

(52) U.S. Cl. 60/641.15; 428/34; 52/204.62

(57) ABSTRACT

Placing a vacuum between two panes of glazing material will form a glazing panel which is a perfect insulator against heat loss by conduction. However, at sea level air pressure of 14.7 psi, the glazing panel would have to resist a crushing force of about 2117 pounds per square foot. Rather than use mechanical pane separators as in prior art, in the present invention an electric charge cloud is trapped on or between the two layers of glazing material, in the vacuum space,in the vacuum space between them and the mutual electrostatic repulsion of the electrons or holes therein provide sufficient force to maintain separation of the glazing layers. The resulting panels may be seasonally or permanently attached to the sunny sides of buildings to trap solar heat, rendering them self-heating or used as window, greenhouse glazing etc.

### BACKGROUND OF THE INVENTION

Heat can be transferred by three mechanisms; convection, conduction and radiation. The ideal means of trapping solar energy for heating therefore would allow solar radiation (at least incoming) to pass into the heat receiver (such as a house or boiler or garden area), which comprises a solar radiation absorbing surface or surfaces, enclosed or protected so as to prevent loss of this acquired heat beyond the space to be heated, where it will heat the reciever's surface, but block convection and conduction, so as to prevent the heat from being removed by the ambient air. A transparent sheet or film as the enclosure means (or “cover sheet”) will pass the incoming solar radiation and prevent convective loss by blocking air motion beyond the desired space to be heated. This may be sufficient for certain applications. However, to achieve true efficiency and therefore be able to for example heat a house in any climate and any season except the Arctic or Antarctic 6 month winter, using only the natural solar influx,

The windows and the cover sheets must also resist conductive loss to the greatest degree possible. Placing a vacuum between two roughly parallel transparent panes or sheets of which the window or “cover sheet” is composed will achieve a theoretically infinite and in practice extremely high resistance to conductive thermal loss, thus solving this problem. The “R” factor is a standard measure of resistance to conduction loss of heat. A single layer of glazing (glass or plastic) will typically have an R value of 1. Plain double glazing may rate 2.5 R. The fanciest double or triple glazing tilled with Argon or Krypton may reach R-8. Recommended wall and ceiling insulation values in medium to cold climates range from R-19 to R40.The goal of this application is to describe several ways to make an affordable R-100 vacuum glazing, for use in windows, window walls, removable southern side enclosures for heating houses in winter (see FIG. 2), cover sheets for all types of solar thermal collectors and geodesic domes and other shapes of enclosures for greenhouses and living spaces in cold locations, on Earth or elsewhere. I should be noted that if the cost is sufficiently low, and durability high, these vacuum panels, transparent or otherwise may supplant or supplement ordinary building and other insulations.

The problem with putting the vacuum between two panes or sheets is the high crushing force imposed by the atmosphere, 14.7 psi at sea level, or close to 2,000 lbs per square foot. Thus there are obvious safety (i.e. projectile) problems and other problems with using any shatterable material such as most glass and certain plastics. The main technical difficulty is to support the two panels against the atmospheric pressure, while keeping the panels light enough so as not to be too expensive(due to material costs such as clear plastic) and so as not to be too heavy for the typical homeowner to emplace and remove them seasonally (considering that a panel might be as big as 4′×20′.

Two approaches to maintaining the separation of the two opposing panes of the vacuum glazings will be described herein: Electrostatic separation, and Mechanical separation (new developments).

ELECTROSTATIC SEPARATION OF THE VACUUM GLAZING PANES: This idea occurred to me in 1980 as I was leaving the PTO at it's then Crystal. City location where I had been searching the field of vacuum insulation and saw the (apparently) curved glazing of the facade of the Crystal City Marriott Hotel, and thought “how could that curve ever be smoothly achieved with mechanical separation of the panes?” when it suddenly occurred to me in a blinding epiphanous flash of inspiration:

“Put an electric charge on the two panes in the space between the two panes, and since all the charges will be alike, the electrostatic repulsion will hold the panes apart against the air pressure and since the electrostatic repulsion will push the panes apart from their contact position, it is possible that no vacuum pump will be needed!”

Indeed it may be this simple: “Two panels of material which are dielectric at least in one layer across their thickness, hermetically sealed around their perimeter, with a region of electrically charged vacuum between them.”

This electric charge may be provided either by an external voltage (presumably electrons not holes) source or by photonic (such as from the appropriate wavelengths of the solar influx) or other stimulation of an electron source. In the case of photonic stimulation, it would be as if in effect solar electric cells or at least the photovoltaic components thereof comprise the entire expanse of one or both panes, their structure oriented orthogonal to the plane of the pane so that the electrons are deposited on the inner surface of the pane and the holes pumped to the outer surface (or vice versa), where they may be collected by a conductive feature (transparent coating/grid/dopaniiintrinsic quality etc.) and dumped to ground.

The electric charge may also be provided by a sufficiently rich intrinsic electron source or accumulator species which is a component of (either chemically integral to, an additive to or (micro)fabricated into, more especially their inner surface. Examples of such integral inner surface components are such as a carbon or hetero polymer, rich in benzene rings such as polycarbonate, graphite or of especial interest graphene(which is a single atomic layer of graphite, layed flat although we may use numerous such layers, if transparency will permit) which with their dense Pi electron clouds may have great electronic repulsivity, or which is rich in 5-membered rings which can only achieve aromaticity or resonance by promoting an electron into the vacuum cavity. Alternatively the material of the inner surface could be an acrylic plastic which is notorious for acquiring static electric charges, or PTFE with its profusion of electro-negative Flourine atoms. The inner surface may be doped or coated even with a single or few molecular layers so as to make it electrically conductive so that charge may be distributed (such as from an external source). An inner layer of Acrylic or other charge carrier may be laminated with an outer layer that is tougher, more electrically insulating and/or more UV resistant.

There has been interest in aerogels between two panes as super-nsulative glazing, but they are translucent, not transparent If the wall or matrix size of the cells in the gel could be sufficiently reduced and/or the cell size could be sufficiently increased or reduced, so as to out of the range of optical interaction, i.e. 1-10 micron, and/or the overall density of the aerogel could be sufficiently reduced, then the aerogel could be transparent. Injecting static electric charge into the aerogel layer would allow this structural lightening of the aerogel due to the repulsive electric force. Furthermore and synergistically, if the aerogel material is prone to being electrically charged (either positive or negative), then a much greater number of charges could be packed into the aerogel/vacuum layer (for a given voltage, and it is a safety goal to keep the voltage low) causing a greater repulsive force (for a given voltage), than would be the case for a naked vacuum, due to the adherence of the charges to innumerable sites throughout the aerogel's 3-d molecular web. Also, as to means of manufacture, it could be that allowing the aerogel to form in a charge injected condition will cause it to have this much finer/transparent structure.

Carbon or other fibers or nanotubes stood on end in the vacuum space have been cited by myself and others as a mechanical means of pane separation. The ideal means to make them stand on end both for manufacture and during use and/or if vacuum is ever lost and the glazing disturbed which results in the carbon fibers or nanotubes falling out of their evenly distributed position, is by injecting electric charge into the space they occupy before the vacuum is drawn in the glazing panel. Furthermore, the same synergism of charge allowing finer fiber/nanotube size as described for aerogels should apply here. The poly aromatic structure of carbon fibers and nanotubes should be especially susceptible to electostatic repulsion under electron (not hole) (charge) injection. Safety may rule out this approach due to inhalation hazard.

It is known in the art that “for a gas, the greater the molecular weight (MW) the lower the heat transfer rate.” Hence the use of Krypton and Argon in high-end conventional thermopane windows. Radon, at the end of this noble gas series and the highest MW gas at relevant climatic temperatures, is ruled out for several obvious reasons such as radioactivity, carcinogenicity, scarcity and cost, as are the halo-carbons.). However charge injection should promote non-gaseous nano-materials (those which are susceptible to absorbing multiple and dispersed surface charges), to a gaseous condition, due to the greatly increased ratio of ‘repulsion vs. distance and mass’, I.e. their effective radius will be greatly increased due to their net negative or positive charges, and their ‘mean free path’ so that they will effectively fill the insulating layer between the two panes as a pressure resisting gas, a “Virtual Gas”

It would seem that the C60 and smaller Buckyballs would be an excellent species for this purpose (Virtual Gas), as their liberal sprinkling of 5-membered rings cry out for extra electrons, so that they may be readily promoted to the sublime condition of resonance merely by connecting a wire full of electrons, and these extra electrons adsorbed onto the Buckyballs where they will provide the repulsive charge imbalance required.. This effect might occur at 20 volts or less. Of course, risking the dispersal of any nano-particle species in such great numbers may be entirely untenable from a safety perspective.

The amount of voltage needed to produce sufficient separation between the panes to prevent thermal transfer and the total amount of charge which would be contained in a large pane is not yet certain and depends on the method of electronic separation chosen. The overall choice will favor that method which works at the lowest possible voltage and total charge . . . for obvious safety reasons. However, if one method has outstanding simplicity and a freedom from dangerous particulates, even if it requires a higher voltage, this form may predominate. Therefore, several electronic safety features will now be described, along with features of the charge injection system for those forms which are not self charging.

Any DC source, continuous or intermittent, of sufficient voltage and correct polarity, will suffice to charge the internal vacuum layer (space) of the glazing. It may even be a single polarity source. In either case the desired polarity (generally electrons not holes i.e. positive not negative) is connected to the internal vacuum space via an electrode either exposed to the vacuum space and/or in contact with the inner surfaces of the panes (especially if they are electrically active i.e. electron or hole absorbing and/or conductive as described 7 paragraphs above). If DC, the other power lead may be grounded or connected to the outer surfaces of the panes, or these may also be grounded which is best from a safety perspective.

A diode or one way electronic valve may be installed in each power feed wire to a glazing unit arranged so as to prevent its discharge through the feed. This would allow intermittent or pulse charging by preventing discharge.

A voltage sensor may be connected to the power feed/internal cavity so as to sense when the internal voltage is too low, so it will then close a switch-able element in the recharging circuit until the correct voltage is attained.

If a higher voltage is required than ordinary diodes will tolerate, line voltage may be transformed to a tolerably low voltage, this rectified by diodes to half wave DC, which can then be transformed to as high a voltage as is required for the vacuum space to be maintained by the resultant charge.

If more than a very low voltage (such as 5V or 10 V) is employed to charge the vacuum space, and especially if there is more than a very small amount of charge in there, i.e. because the electrified vacuum window is essentially a capacitor, there should be safety devices. These include:

A ground fault or voltage leakage detector, which closes a switch-able element(s) connecting the electrified vacuum space to ground or other wise instantly discharges it, and/or interrupts the power feed from the power source to the vacuum space.

Whereas material' tensile strength increases when they are in thin films (and fibers), multiple layers of thin films including glasses and plastics such as polycarbonate, mylar, polyester, acrylic and EVA could be laminated together until the required strength is achieved. If the indexes of refraction match, then there will not be transmissive refractive or reflective losses due to the multiple material boundaries between these thin film layers.

This aspect of the invention is a boiler-less steam engine of pressure expansion configuration, most probably reciprocating piston in cylinder connected to crankshaft, although it could be free piston, Wankel, rotary, rotary-vane etc, the key feature being that the cylinder or pump body expansion chamber is heated on its outer surface by (concentrated) solar in-radiation, fuel combustion, nuclear fission or fusion heat source; and water or other (preferrably) liquid phase working fluid is squirted at pressure and in correct timing vs piston onto the inner surface of said heated cylinder head pump-body expansion chamber wall, whereupon it instantly flashes into high pressure steam and pushes said piston, rotary-vane device etc.

It should be appreciated that the cytinder-head/pump body expansion chamber could be extremely hot, such as 1000 F. from concentrated solar energy or direct insertion into a residential fireplace (after removal of “glass cover jar” and “parabolic reflector”) As F. A. and F. O. Stanley proved with their flash boilers, it is not the mass of working fluid, but the temp of the hot side of the system that governs power and efficiency (Law's of Thermodynamics

Therefore, this engine would be built with a thermostatic intrinsic control, so that less H20 is injected when engine cylinder head-pump body expansion chamber is not so hot, more H20 when cylinder-head pump body approaches its melting point.

This Neg. Feedback could be caused by the expansion of the cylinder-head itself which moves the H20 injection pump+thus varies its stroke volume.

### DESCRIPTION OF THE DRAWINGS

(Figures are renumbered. FIGS. 1,2 and 3 are new but contain no new matter and adhere strictly to the specification. The 2 varieties of hermetical seal joints are included for teaching purposes but will not be claimed in this patent.)

FIG. 1 shows a basic two layer electro-repulsive vacuum glazing or panel in which 101 is the two layers of sheet material (which for a glazing panel would be transparent). 102 is the vacuum in the interlayer space. 103 is the hermetical seal around the perimeter of the panel which is of the squashed butt joint type. 104 is the similar electric charges in the interlayer space, which charges may be positive or negative. 105 is the out ward pressure caused by the similar electric charges 104, which holds the two layers of sheet material apart to allow space for the vacuum and prevent heat conduction across the insulating panel/glazing. 106 is the atmospheric pressure attempting to crush the layers together, shown being balanced and opposed by outward pressure 105.

FIG. 2 is an enlargement of FIG. 1.

FIG. 3 shows a hermetical seal which is a lap joint in which bottom layer 101 is upturned 301 at the perimeter, and upper layer 101 is downturned at the perimeter so as to overlap 301, with a fused joint 303 in the overlap region.

FIG. 4 shows a typical house 401 without a vacuum glazed enclosure on its sun facing exposure, which results in the solar radiation 402 which strikes and heats the surface 403 of the house and the surface of the ground 404, which heats the air and is lost by convection 405 into the environment.

FIG. 5 shows the same house but with an enclosure composed vacuum glazing panels 501, 502 assembled on the sun facing exposure so as to trap the currents of air 505 which were heated by the insolation 402 thus heating the enclosed space 506. Window and doors 507 and roof vents or manifolds 508 are to be opened during the day to allow this heat into the house. 501 shows a Electro-repulsive-vacuum-glazing, and 502 shows as mechanically separated vacuum glazing.

FIG. 6 shows a thermal expansion engine 601 being powered by solar insolation 602 which strikes parabolic reflector 603 and is reflected to and concentrated upon cylinder head 604. Heat loss from 604 is prevented by the transparent cover 605 and vacuum 606. As the piston 608 approaches Top Dead Center water is injected and sprayed 609 upon the underside of the solar heated cylinder head 604 and promptly turns to steam which drives piston 608 down cylinder 609 pushing connecting rod 610 which turns crank 611.

FIG. 7 is FIG. 6 but also shows water injector pump 701 being pulsed once per crank revolution by crank mounted cam 702, and exhaust valve 703 being opened once per crank revolution by crank mounted cam 704.

FIG. 8 shows an improvement in which there are water passages 801 or a water cavity 801 built into the cylinder head 604 so as to superheat the water (or other working fluid), shown here in the underside of it, and the admission of the water/steam from 801 into the expansion chamber/cylinder is caused by the piston striking and pushing upon admission valve 802.

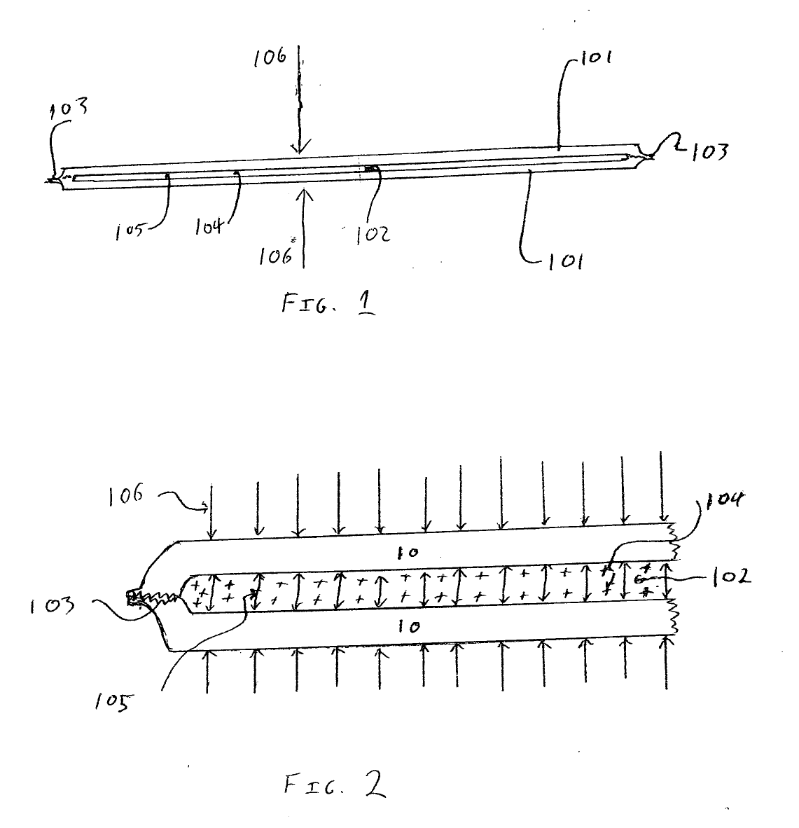

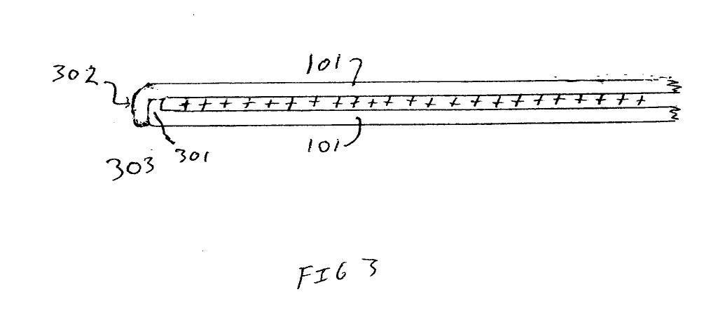

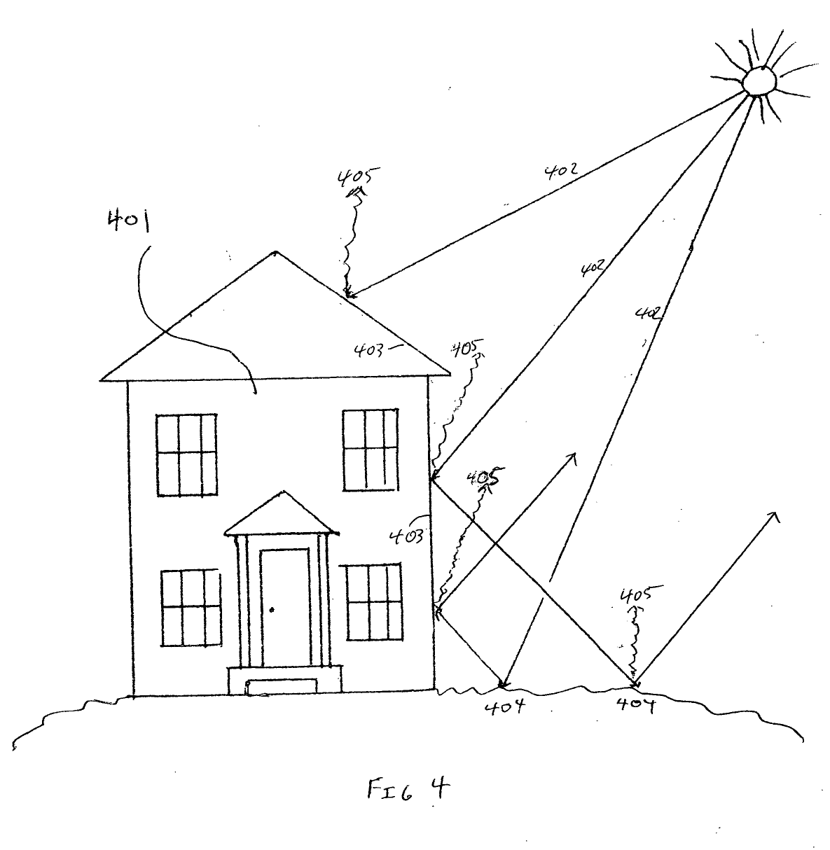

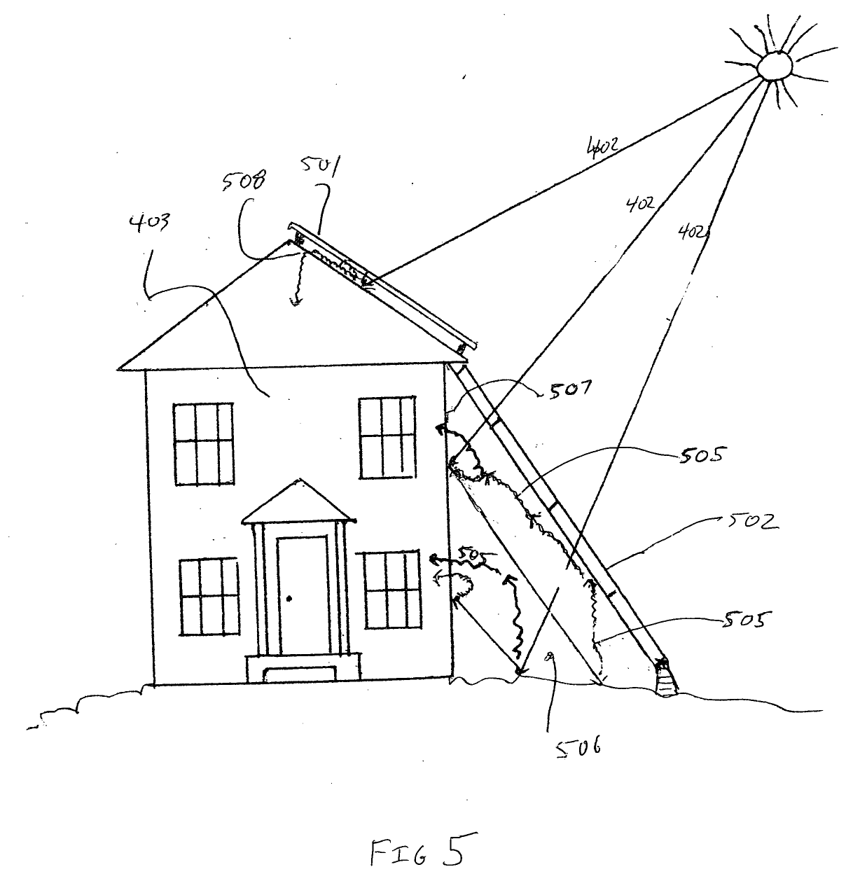

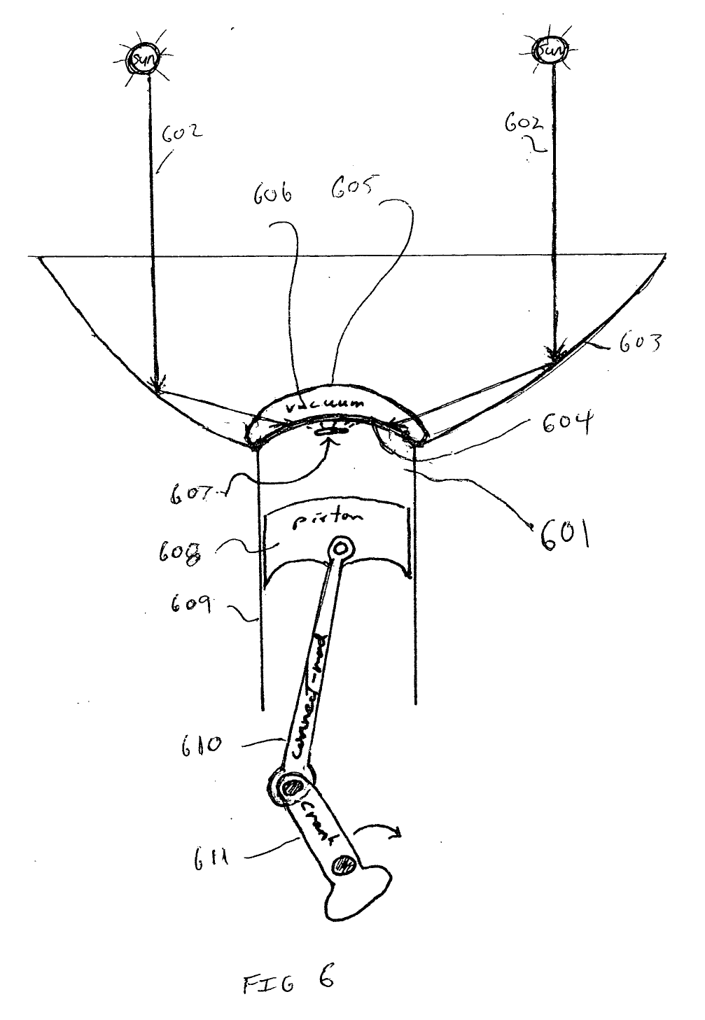

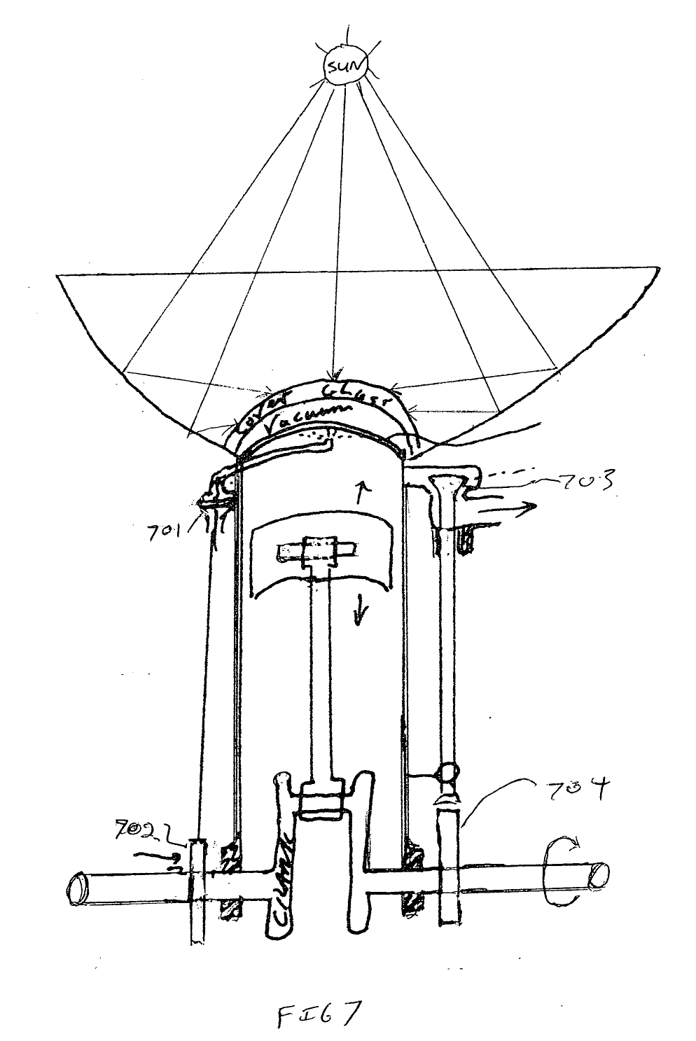

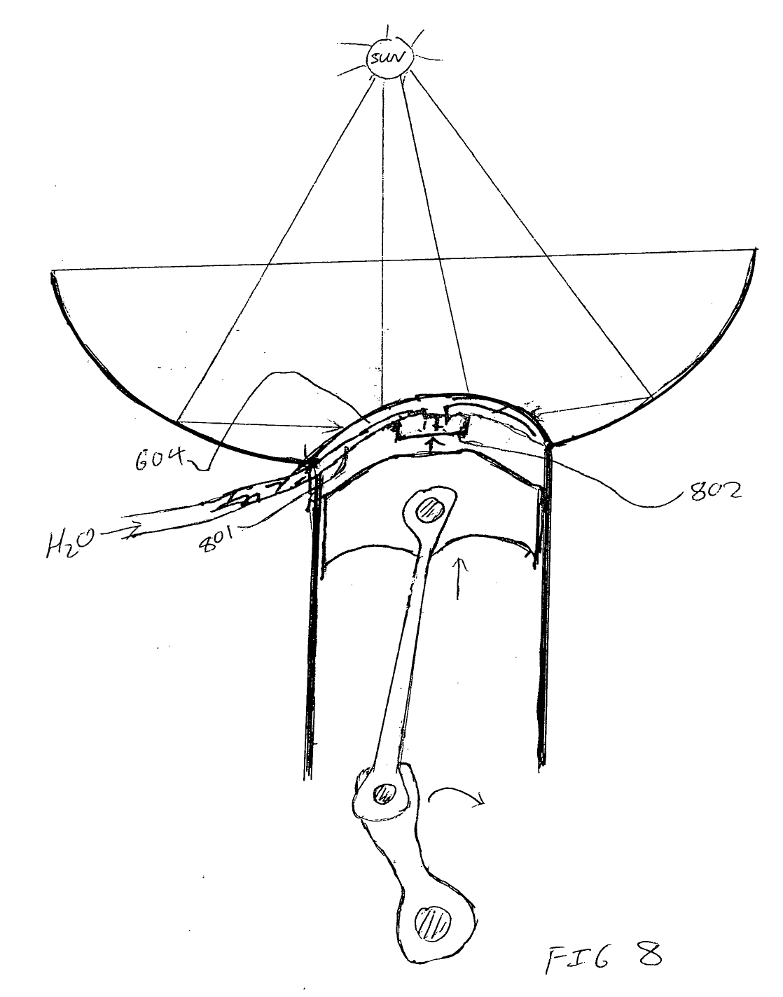

What is claimed is:

1) A vacuum insulation comprised of matched layers of sheet material hermetically sealed around their perimeter, with a vacuum between them and with an electric charge also on the sheet's inner surfaces and/or in the same interlayer space as the vacuum, so as to provide a repulsive force to separate the layer/sheets and thus prevent heat transfer across the panel by conduction.

2) The apparatus as claimed in claim 1 in which the materials are transparent so as to create a vacuum insulated glazing made of [two] matched layers of [glass or plastic] transparent sheet material, hermetically sealed around their perimeter, with a vacuum between them, and with an electric charge also on the sheet's inner surfaces and/or in the same interlayer space as this vacuum, so as to provide a repulsive force to separate the transparent [two] layers [of plastic or glass, and thus prevent heat transfer across the glazing by conduction.

3) The apparatus as claimed in claim 1 and comprising more than two layers of sheet material.

4) The apparatus as claimed in claim 1 wherein no vacuum pump or source is required because the separating movement of the layer-sheets from their position of initial contact, caused by the electric charge, establishes the vacuum space.

5) The apparatus as claimed in claim 1 wherein the electric charge of the interlayer insulating vacuum space is caused, provided or increased by photoelectric material associated with either or both layers of transparent material or the interlayer space, which converts photons striking it into electric charges in the interlayer space.

6) The apparatus as claimed in claim 1 wherein either or both layers of transparent material are electrically conductive so as to disperse electric charge in the interlayer space.

7) The apparatus as claimed in claim 1 wherein a material component or additive of the transparent layers readily accepts an electric charge.

8) The apparatus as claimed in claim 7 wherein the material component or additive of the transparent layers is acrylic or polycarbonate.

9) The apparatus as claimed in claim 1 wherein an atomic or molecular species which readily accepts electric charge is in the interlayer space.

10) The apparatus as claimed in claim 1 wherein nano-particles which readily accept electric charge are dispersed in the interlayer space.

11) The apparatus as claimed in claim 1 wherein Buckyballs which accept electric charge are dispersed in the interlayer space.

12) The apparatus as claimed in claim 1 wherein an aerogel is dispersed in the interlayer space, which may accept electric charges so as to increase the electro-repulsive force between the transparent layers, and so as to structurally stabilize same aerogel.

13) The apparatus as claimed in claim 1 wherein fibers is in the interlayer space, which may accepted electric charges so as to increase the electro-repulsive force between the transparent layers, and so as to structurally stabilize, orthogonally orient and equally distribute said fibers.

14) The apparatus as claimed in claim 13 wherein said fibers are carbon fibers or nano-tubes.

15) The apparatus as claimed in claim 1 wherein the electric charge in the interlayer space(s) comes from electrical connection with an external power source.

16) The apparatus as claimed in claim 15 where in a diode is connected between the electrical source and the interlayer space, oriented so as to allow appropriate charge injection and prevent its loss.

17) The apparatus as claimed in claim 1 and additionally with an electrical ground connection to the outer surface(s) of the panel.

18) A solar or other radiative heat thermal internal expansion engine in which the incoming radiative energy is absorbed by a region of the expansion chamber, which in turn heats a working fluid which is admitted to the expansion chamber to produce power, by moving a moveable portion of said expansion chamber.

19) An enclosure comprised, at least on sides facing the sun, of transparent panels of at least two layers of material, sealed around the perimeter, with a vacuum in the interlayer space(s).
